(19) United States
(12) Patent Application Publication
(10) Pub. No.: US 2005/0019744 A1
(43) Pub. Date: Jan. 27, 2005

(54) Ultrasound-assisted ischemic reperfusion

(75) Inventor: Silvia Bertuglia, Pisa (IT)

Correspondence Address: O'MELVENY & MEYERS, 114 PACIFICA, SUITE 100, IRVINE, CA, 92618, US

(73) Assignee: LA JOLLA BIOENGINEERING INSTITUTE

(21) Appl. No.: 10/627,275

(22) Filed: Jul. 25, 2003

(51) Int. Cl. A01N 1/00

(52) U.S. Cl. 435/1.2

(57) ABSTRACT

A method for stimulating perfusion and minimizing postischemic reperfusion injury. A patient is selected having compromised perfusion in a tissue or in the microcirculation of an organ. An ultrasound transducer is applied to a location near the tissue. The transducer is activated to initiate exposure of the tissue to ultrasound at a frequency of 100 KHz to 2.5 MHz for 0.5 to 15 minutes duration, wherein local vasodilatation is stimulated. In certain cases, the methods further include a step of confirming that local vasodilatation is stimulated by measuring enhancement in perfusion. Ultrasound devices are also described for carrying out the methods. The devices and methods can be used to enhance myocardial perfusion, cerebral perfusion, and perfusion of transplanted tissues.

### FIELD OF THE INVENTION

The invention relates to devices and methods for reducing tissue damage during postischemic reperfusion. More particularly, the invention relates to the use of ultrasound exposure to assist postischemic reperfusion in the microcirculation and reduce tissue damage after an ischemic event, including myocardial infarction, stroke, or tissue or organ transplant.

### BACKGROUND

In the United States each year approximately 1.5 million patients experience a myocardial infarction from atherosclerotic coronary disease. The pathological sequence of events leading to acute myocardial infarction includes plaque rupture with exposure of the subintimal surface of the plaque to coronary blood flow. As a result, activation of platelets and the coagulation pathway occurs as the contents of the atherosclerotic plaque interact with circulating blood components. Platelet activation also releases numerous chemical mediators, including thromboxane A2, a vasoconstrictive substance that often leads to localized vasospasm that further impedes coronary artery blood flow. The result of these events is thrombus formation causing interruption of coronary blood flow to myocardial tissues, causing myocardial necrosis.

At the cellular level, hypoxia, i.e., interruption of oxygen supply caused by diminished blood supply, initially affects oxidative phosphorylation by mitochondria, i.e., a cell's aerobic respiration. Other cellular changes, including detachment of ribosomes from the granular endoplasmic reticulum, may also occur. If oxygenation is restored, these cellular disturbances are reversible. However, if ischemia persists, further damage to cellular structures occurs, leading to digestion of lethally injured cell by lysosome enzymes and ultimately cell death. Two important phenomena are known to contribute to lethal hypoxic injury. The first is the cell's inability to reverse mitochondrial dysfunction upon reperfusion or reoxygenation. The second is the development of profound disturbances in membrane function.

Toxic oxygen free radicals have been implicated as one of several important mechanisms responsible for causing membrane damage in irreversible cell injury. It is known that such free radicals are highly toxic to cell membranes and other cellular constituents and are produced at very low levels in ischemic myocardium during ischemia. However, upon restoration of blood flow, production of free radicals is increased. Reperfusion, therefore, results in a paradoxical effect—an increase in cell damage called reperfusion injury. These toxic oxygen radical species (ROS) are thought to be produced largely by leukocytes that infiltrate the site of ischemia during reperfusion. Generation of ROS immediately upon reperfusion has been demonstrated in experimental conditions, as well as in patients with acute myocardial infarction undergoing thrombolysis, coronary angioplasty, or coronary artery bypass grafting surgery. Interaction of ROS with membrane lipids and essential proteins contribute to damage, leading to vasoconstriction and leukocyte adhesion on the endothelial surface with concomitant depletion of certain key endogenous antioxidant compound.

The reperfusion ischemic injury can be reduced by antioxidant in some but not all models of ischemia. Therefore, new devices and methods are needed to reduce cellular damage during ischemic reperfusion.

### SUMMARY OF THE INVENTION

Microcirculatory damage is a crucial pathogenic mechanism in the induction and propagation of damage in ischemia-reperfusion (I/R)-induced injury associated with decreased perfusion, especially in acute myocardial infarction. The present invention relates to methods and devices for stimulating reperfusion so as to minimize microcirculatory damage after an ischemic event. In a first method, a patient is selected having a tissue with compromised perfusion, such as a myocardial infarction. An ultrasound transducer is applied to a location near the heart, e.g., on the chest above the heart, preferably in the area of the coronary occlusion. It may be desirable to apply a gel to enhance transmission of transcutaneous ultrasound.

The transducer is activated to initiate exposure of the myocardium and coronary arteries to ultrasound. The exposure to ultrasound causes local vasodilatation of the coronary arteries through shear stress-stimulated production of nitric oxide and/or attenuation of oxygen free radical species thus determining vasodilatation and protecting the endothelial barrier during reperfusion. Ultrasound treatment is likely to be most effective if initiated within 30 minutes of the myocardial infarction. Ultrasound treatment may be accompanied by injecting an anticlotting agent into the patient, the anticlotting agent being any of aspirin, tissue plasminogen activator, and/or streptokinase.

Exposure to ultrasound will be maintained for a duration of time, usually 0.5 to 10 minutes, more preferably 5 to 10 minutes, in some cases longer than 10 minutes, and in other cases up to 15 minutes or more than 15 minutes. In certain cases it may be desirable to confirm that local vasodilatation has been stimulated. Measuring enhancement of perfusion can confirm that local vasodilatation has been stimulated. Angiography, electrocardiogram, diagnostic ultrasound, and measuring blood levels of creatine kinase can be used to measure enhancement of perfusion in the coronary arteries. Typically, a baseline coronary blood flow is measured before treating the ischemic condition. Then, after ultrasound exposure, coronary blood flow is measured again and compared with the baseline measurement to determine the level of enhancement. In certain cases, ultrasound exposure will be repeated a second time, or more, until normal blood flow to the ischemic tissues is established.

In another method, a patient is selected having a cerebral tissue with compromised perfusion, e.g., a stroke. An ultrasound transducer is applied to a location near the head and/or neck, preferably in the area of the cerebral vascular occlusion. A gel may be used to enhance transcutaneous ultrasound. The transducer is activated to initiate exposure of the head or neck to ultrasound. Cerebral blood flow is enhanced by dilating one or more of the right brachiocephalic trunk, left common carotid artery, left subclavian artery, right common carotid artery, right subclavian artery, left internal carotid artery, left middle cerebral artery, left anterior cerebral artery, right internal carotid artery, anterior cerebral arteries, anterior communicating artery, right posterior communicating artery, left posterior communicating artery, right posterior cerebral artery, left posterior cerebral artery, left vertebral artery, right vertebral artery, basilar artery, femoral artery, brachial artery, a carotid bulb, and any other arteries of the head and neck that provide cerebral perfusion. In certain methods it is desirable to use transcranial Doppler or carotid Doppler to confirm the enhancement of cerebral blood flow during or after application of ultrasound therapy.

In another method, a patient is selected having a tissue or organ transplant, e.g., a kidney, liver, heart, or lung transplant, or a tissue or skin graft. An ultrasound transducer is applied to a location near the transplanted tissue. A gel may be used to enhance transcutaneous ultrasound. The transducer is activated to initiate exposure of the transplanted tissue to ultrasound. Local vasodilatation is stimulated to enhance early reperfusion and minimize oxygen free radical injury. In certain methods it is desirable to confirm the enhancement of blood flow during or after application of ultrasound therapy using angiogram or ultrasound with Doppler.

### BRIEF DESCRIPTION OF THE DRAWINGS

FIG. 1A depicts application of ultrasound to enhance reperfusion following myocardial infarction.

FIG. 1B depicts application of ultrasound to enhance reperfusion following stroke.

FIG. 1C depicts application of ultrasound to enhance reperfusion following kidney transplant.

FIG. 1D depicts application of ultrasound to enhance reperfusion following liver transplant.

FIG. 2A is a schematic outlining the experimental protocol used in this study.

FIG. 2B depicts modifications in diameter of arterioles during baseline and in the groups treated with US exposure (US), subjected to I/R (I/R) and those treated with ultrasound exposure and subjected to I/R (USR), respectively. See the text for details. Values are means ±SD, n=15 experimental observations for each entry, *p<0.01 vs. baseline °p<0.05 vs. I/R.

FIG. 3 depicts changes in arteriolar RBC velocity at baseline and in the groups treated with US exposure (US), subjected to IR (I/R) and those treated with ultrasound exposure and subjected to IR (USR), respectively. See text for details. Values are means ±SD, n=20 experimental observations for each entry, *p<0.01 I/R vs. baseline, °p<0.01 vs. I/R.

FIG. 4 depicts permeability (normalized to baseline) during baseline and in the groups treated with US exposure (US), subjected to I/R (I/R) and those treated with US exposure and subjected to I/R (USR), respectively. See text for details. Values are means ±SD. *pM0.01 vs. baseline; °p<0.01 vs. I/R.

FIG. 5 depicts leukocyte adhesion expressed as adhering leukocytes/100 μm venules at baseline and after the period of reperfusion in the group treated with saline (I/R) and those treated with ultrasound (US). See text for details. Values are means ±SD, n=25 experimental observations for each entry, *p<0.05 when compared with baseline, °p<0.05 when compared with I/R group.

FIG. 6 depicts percentage change of the perfused capillary length (PCL) at baseline and after the period of reperfusion in the group treated with saline (I/R) and those treated with ultrasound (US). See text for details. Values are means ±SD, *p<0.05 vs. baseline; °p<0.05 vs. I/R.

FIG. 7 depicts photographic sequence of a control hamster cheek pouch microcirculation during baseline, 30 min of ischemia, 5 min and 30 min of reperfusion. See text for details.

FIG. 8 depicts photographic sequence of an US treated-hamster cheek pouch microcirculation during baseline, 30 min of ischemia, 5 min and 30 min of reperfusion. See text for details.

FIG. 9 depicts lipoperoxides measurements in the systemic blood of hamsters treated with ultrasound during baseline, at 5, 30 min of ischemia, and at 5, 15, 30, 40 min of reperfusion. We reported also the value at 5 min of obtained by measuring blood samples withdrawn after declamping the cheek pouch. Error bars indicated SD. *pM0.05 vs. baseline; °p<0.05 vs. I/R.

### DETAILED DESCRIPTION

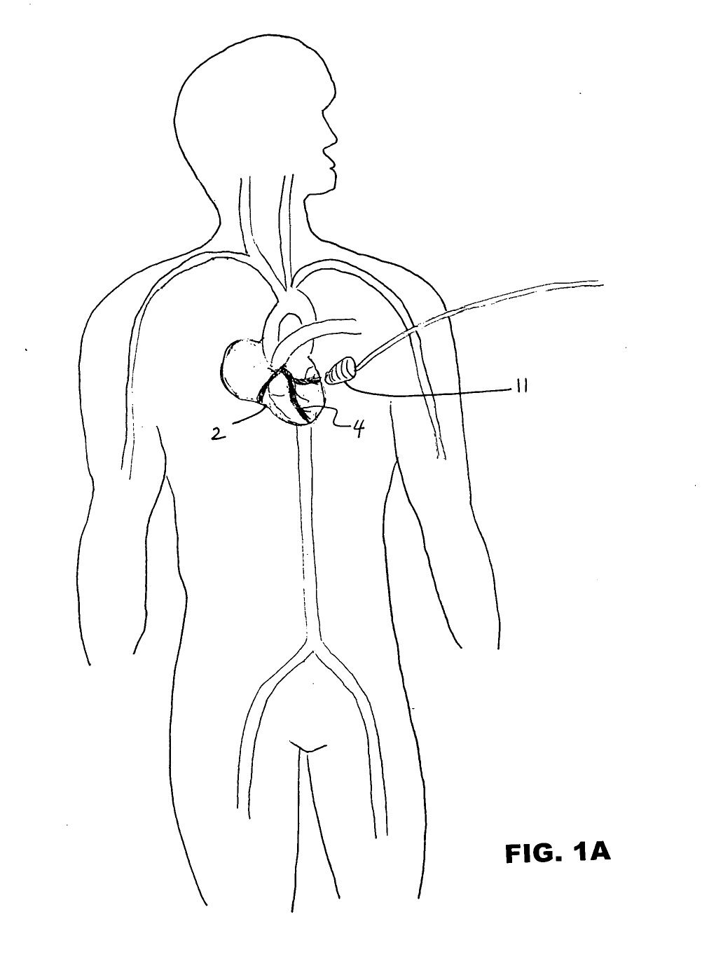

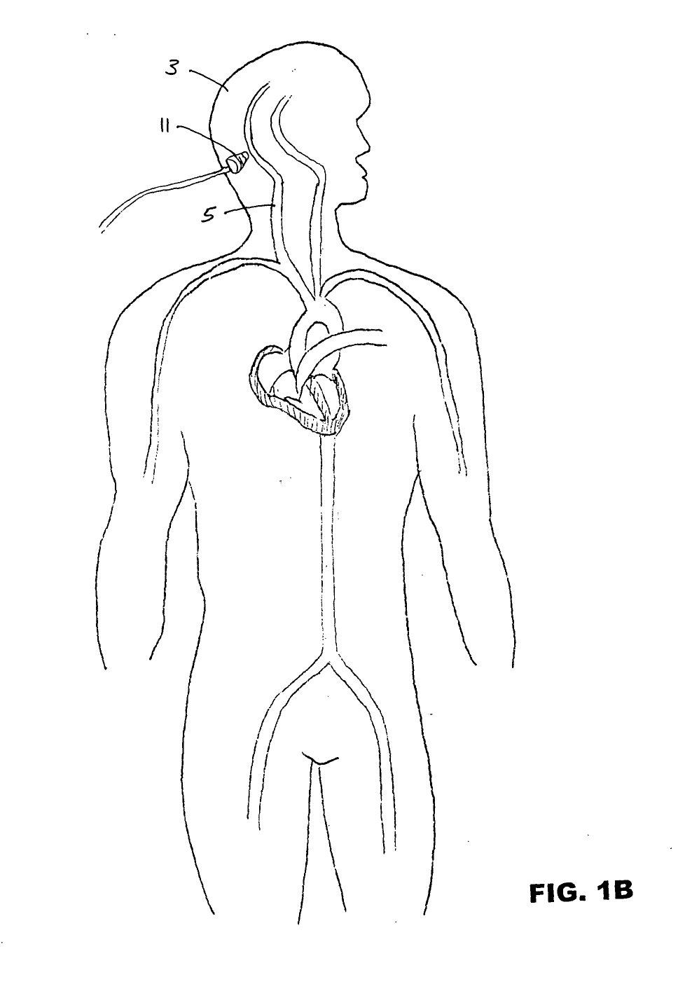

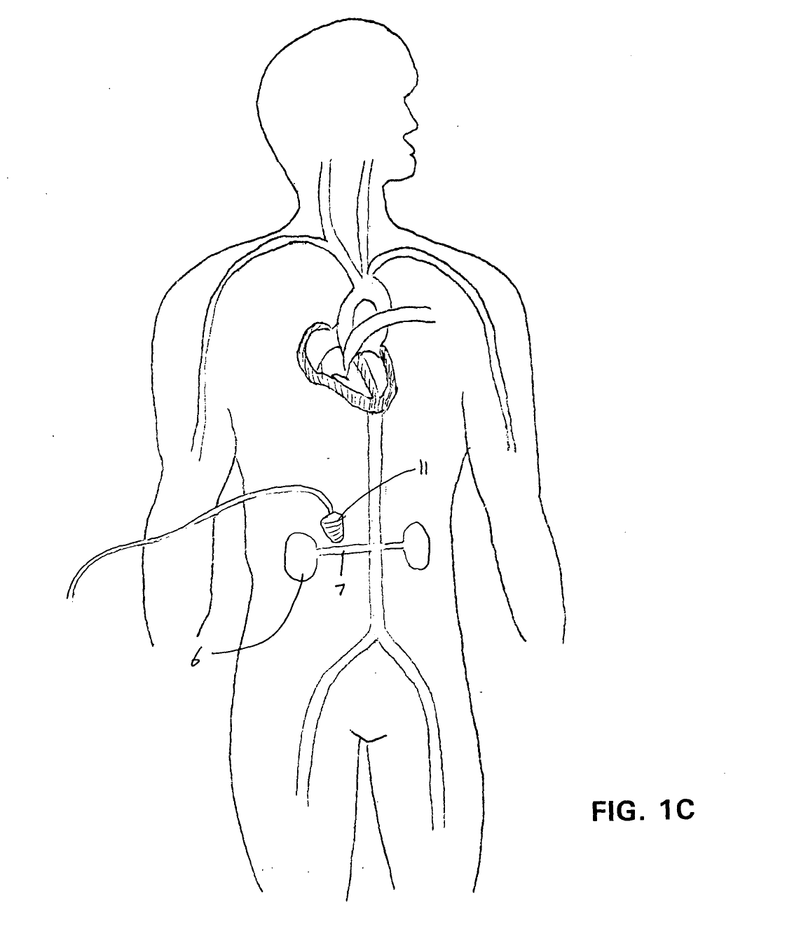

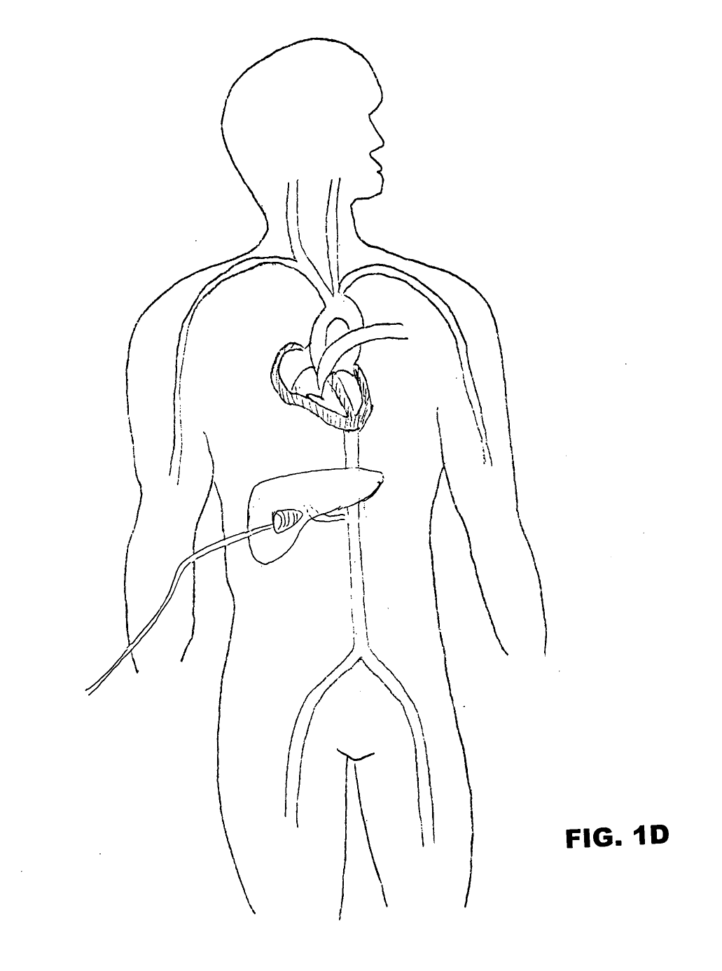

In a first method for stimulating reperfusion, a patient experiencing a myocardial infarction is selected as shown in FIG. 1A. A portable transcutaneous ultrasound transducer 11 is applied, preferably within 30 minutes after the ischemic injury, to a location near the tissue at the site of the ischemic injury, in this case heart 2. The transducer is activated to initiate exposure of the tissue to ultrasound and thereby stimulate local vasodilatation of coronary arteries 4. The establishment of reperfusion in the effected coronary artery is confirmed after ultrasound therapy.

Optionally, a gel is applied to enhance the transmission of ultrasound waves. The focal length of the ultrasound waves is adjusted. The frequency of the ultrasound waves is set at 100 KHz to 5.0 MHz, more preferably at a frequency of 100 KHz to 2.5 MHz, more preferably at a frequency of 100 KHz to 2.0 MHz, more preferably at a frequency of 100 KHz to 1.0 MHz, more preferably at a frequency of 100 KHz to 200 KHz. The ultrasound exposure is maintained for 0.5 to 15 minutes, more preferably for 0.5 to 10 minutes, more preferably for 5 to 10 minutes, in other cases up to 15 minutes, and in other cases more than 15 minutes. The transducer may be activated to initiate exposure to ultrasound with a temporal and spatial average energy level of 0.01 to 1.00 watts/cm². The transducer may be activated to initiate exposure to ultrasound with pulsed modulation or with non-pulsed modulation.

After ultrasound therapy, the establishment of reperfusion may be confirmed by a procedure selected from angiography, electrocardiogram, diagnostic ultrasound, and measuring blood levels of creatine kinase. An anticlotting agent may be injected into the patient, such as aspirin, tissue plasminogen activator, streptokinase, or other suitable anticlotting agent.

In a second method for stimulating reperfusion, a patient experiencing a stroke is selected as shown in FIG. 1B. A portable transcutaneous ultrasound transducer 11 is applied, preferably within 30 minutes after the ischemic injury, to a location near the tissue at the site of the ischemic injury, in this case head 3. The transducer is activated to initiate exposure of the tissue to ultrasound and thereby stimulate local vasodilatation of carotid artery 5, or other artery of the head or neck, including the right brachiocephalic trunk, left common carotid artery, left subclavian artery, right common carotid artery, right subclavian artery, left internal carotid artery, left middle cerebral artery, left anterior cerebral artery, right internal carotid artery, anterior cerebral arteries, anterior communicating artery, right posterior communicating artery, left posterior communicating artery, right posterior cerebral artery, left posterior cerebral artery, left vertebral artery, right vertebral artery, basilar artery, femoral artery, brachial artery, a carotid bulb, and any other arteries of the head and neck that provide cerebral perfusion.

Optionally, a gel is applied to enhance the transmission of ultrasound waves. The focal length of the ultrasound waves is adjusted. The frequency of the ultrasound waves is set at 100 KHz to 5.0 MHz, more preferably at a frequency of 100 KHz to 2.5 MHz, more preferably at a frequency of 100 KHz to 2.0 MHz, more preferably at a frequency of 100 KHz to 1.0 MHz, more preferably at a frequency of 100 KHz to 200 KHz. The ultrasound exposure is maintained for 0.5 to 15 minutes, more preferably for 0.5 to 10 minutes, more preferably for 5 to 10 minutes, in other cases up to 15 minutes, and in other cases more than 15 minutes. The transducer may be activated to initiate exposure to ultrasound with a temporal and spatial average energy level of 0.01 to 1.00 watts/cm². The transducer may be activated to initiate exposure to ultrasound with pulsed modulation or with non-pulsed modulation.

After ultrasound therapy, the establishment of reperfusion may be confirmed by a procedure selected from carotid angiography, transcranial or carotid Doppler, diagnostic ultrasound, and measuring blood levels of creatine kinase. An anticlotting agent may be injected into the patient, such as aspirin, tissue plasminogen activator, streptokinase, or other suitable anticlotting agent.

In a third method for stimulating reperfusion, a patient having an organ transplant is selected as shown in FIG. 1C. A portable transcutaneous ultrasound transducer 11 is applied, preferably within 30 minutes after the transplant, to a location near the transplanted tissue, in this case kidney 6. The transducer is activated to initiate exposure of the tissue to ultrasound and thereby stimulate local vasodilatation renal artery 7, or other arteries of the transplanted tissues.

Optionally, a gel is applied to enhance the transmission of ultrasound waves. The focal length of the ultrasound waves is adjusted. The frequency of the ultrasound waves is set at 100 KHz to 5.0 MHz, more preferably at a frequency of 100 KHz to 2.5 MHz, more preferably at a frequency of 100 KHz to 2.0 MHz, more preferably at a frequency of 100 KHz to 1.0 MHz, more preferably at a frequency of 100 KHz to 200 KHz. The ultrasound exposure is maintained for 0.5 to 15 minutes, more preferably for 0.5 to 10 minutes, more preferably for 5 to 10 minutes, in other cases up to 15 minutes, and in other cases more than 15 minutes. The transducer may be activated to initiate exposure to ultrasound with a temporal and spatial average energy level of 0.01 to 1.00 watts/cm². The transducer may be activated to initiate exposure to ultrasound with pulsed modulation or with non-pulsed modulation.

After ultrasound therapy, the establishment of reperfusion may be confirmed by a procedure selected from angiography, Doppler, diagnostic ultrasound, and measuring blood levels of creatine kinase. An anticlotting agent may be injected into the patient, such as aspirin, tissue plasminogen activator, streptokinase, or other suitable anticlotting agent. In this same manner, ischemic reperfusion may be assisted during lung, liver (FIG. 1D), and heart transplants, as well as skin grafts.

### EXAMPLE

Male Syrian hamsters (80-100 g Charles River, Calco, Italy) were used. After general anesthesia with pentobarbital sodium (5 mg/100 g, i.p.) and tracheotomy, the right carotid artery and femoral vein were cannulated to monitor systemic blood pressure and to administer additional anesthesia and drugs, respectively. Animal handling and care followed the procedures outlined in the Guide for the Care and Use of the Laboratories of the Italian Research Council.

Experimental Groups

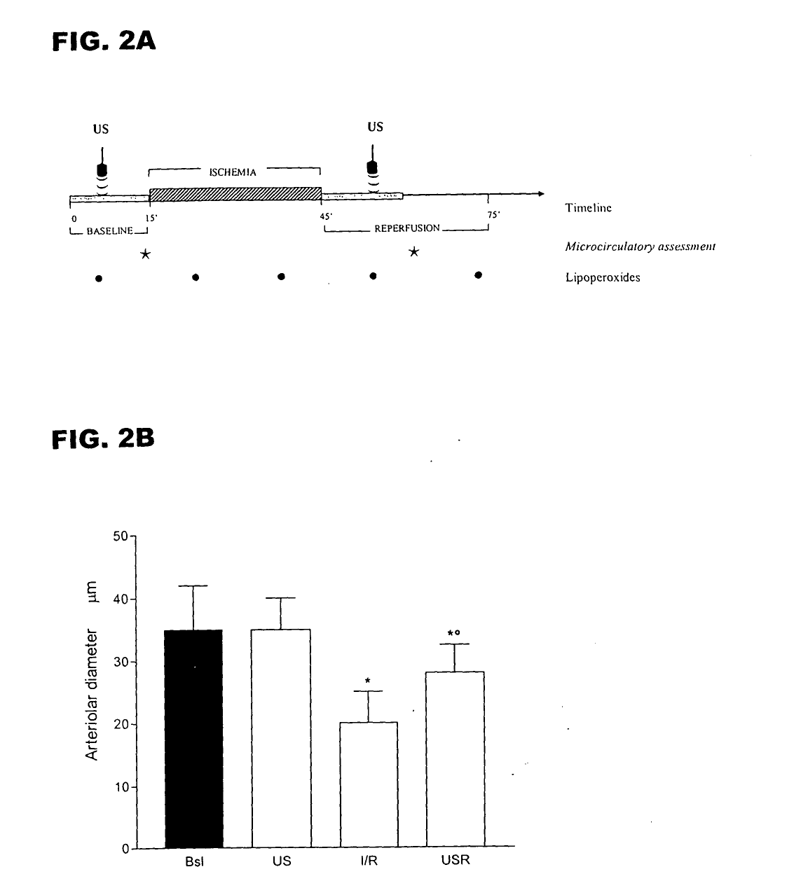

The first group (I/R, n=5) was used to determine the damage during ischemic reperfusion alone, therefore, the ischemic reperfusion protocol was followed and a bolus of 0.9% saline solution was infused via the femoral catheter before ischemia and at the beginning of reperfusion. The second (US, n=10) group was used as control for damage caused during baseline after 15 min of exposure to US. Then the animals were subjected to ischemia (30 min) and at the beginning of reperfusion were subjected to ultrasound exposure (15 min) and then observed for the following period of reperfusion (30 min) (FIG. 2A). 2.5 MHz transducer (mechanical index 1.3 by default, pulse length 400 nsec). Acoustic coupling gel (Aquasonioc® Parker Laboratories) was applied on the transducer that was aligned at 5 cm from the target tissue. The focal depth of the US delivery was also adjusted to 5 cm. The US was directed toward a thin black blade inserted in the cheek pouch. The mechanical index indicates the potential for mechanical bioeffects and is the default display with 2D/B-mode imaging. The mechanical index is calculated using two variables: MI=Peak rarefactional pressure (derated)/Fc. The denominator Fc is the center frequency of the transmitted field.

Experimental Protocol

The left cheek pouch was surgically prepared as previously reported (17, 18). The cheek pouch was spread out over a Plexigas microscope stage. Then a thin black blade was inserted through a small incision between the upper and lower layers of the pouch. The cheek pouch was superfused with a 37° C. Ringers solution (1 ml/min), with 5% CO₂ in 95% N₂ adjusted to pH 7.35. Atraumatic microvascular clips were placed on the proximal part of the cheek pouch to achieve complete occlusion for 30 min during reperfusion. The temperature of the water-heated Plexigas stage was maintained between 35 and 37° C. The cheek pouch was observed with a microscope (Orthoplan, Leica Microsystem GmbH, Wetzlar, Germany) and a filter block (Ploempak, Leica Germany) fitted with a long working distance objective (×4, na 0.14); ×20, na 0.25) and ×10 eyepiece. Epi-illumination was provided by a xenon 150-W lamp using the appropriate filters for fluorescein isothiocyanate, bound to dextran (MV 150,000; Sigma Chemical, St. Louis, Mo., USA; 50 mg/100 g b. wt., intravenously injected as 5% W/V solution in 5 min), for acridine red and a heat filter. The area of interest was captured by a COHU 5253 SIT (COHU Inc. San Diego Calif., USA) low light level camera, and observed on a video monitor (Sony PVM 122 CE) and recorded. Video images were transferred also to the random access memory of a computer and imaging software (Project Engineering Srl, Firenze, Italy) was used to for microvascular image analysis.

Mean arterial blood pressure (MAP) (Viggo-Spectramed P10E2 transducer, Oxnard, Calif., USA) and heart rate (HR) were measured by a Gould Windograf recorder (Mod. 13-6615-10S, Gould Inc., Ohio, USA).

Measurements of Microvascular Parameters

Animals in the ischemic reperfusion groups received an intravenous injection of acridine red (1 mg/100 g) to visualize the leukocytes at baseline and after reperfusion. The number of adhering leukocyte was counted for 30 s in postcapillary venules (diameters in the range 12-30 μm, length >250 μm). Leukocytes were judged to be adherent if they remained stationary for >30 s. The number of adherent leukocytes was expressed as the number/100 μm length of postcapillary venule. In each animal 5 venules were recorded on videotape.

PCL, defined as the total length of capillary segments that have at least one RBC passing through them in a 30 s period, was analyzed from four to six different microscopic fields. Microvessel diameters were measured by an image shearing system (Digital Image Shearing Monitor Mod 907, IPM). Red blood cell (RBC) velocity was determined using dual slit cross correlation (velocity tracker Mod 102 B, IPM, San Diego, Calif., USA). The measured centerline velocity was corrected according to vessel size to obtain the mean RBC velocity.

To quantify the microvascular leakage of FITC-dextran, the fluorescence intensity in the perivascular space was reported as normalized to baseline grey levels: NGL=(I−Iᵣ)Iᵣ, where I is the average baseline grey level and Iᵣ is the same parameter after reperfusion (20). Grey levels, were determined using computerized imaging software (Project Engineering, Florence, Italy). The size of the window used to measure average intensity value was set at 50 μm long and 50 μm wide.

ROS Measurements

To measure plasma hydroperoxides, the analytic method d-ROMs (Diacron s.r.l., Parma Italy) was used based on the Fentons reaction or on radical formation during lipid peroxidation (19, 20). The oxyradical species produced, whose quantity is directly proportional to the quantity of plasma peroxides, were trapped by an alchylamine a phenolic compound able to react forming a colored stable radical detectable by at 505 nm by a spectrophotometer. The concentration of the colored complex is directly correlated to the concentration of hydroperoxides. 10 μl of chromogenic substance and 1 ml of the kit buffer are mixed with 10 μl of blood for 1 min at 37° C. The results were expressed in arbitrary units (a.u.) (1 unit=0.08 mg/100 ml H₂O₂).

Blood samples were taken at baseline, before and after exposure to ultrasound and at 5, 15, and 30 min of ischemia and reperfusion for each hamster from the carotid artery. Five hamsters were subjected to ischemia for 5 min then the cheek pouch was unclamped and ROS were measured in the blood with d-ROMs essay.

All reported values are means ±SD. Differences were tested by paired and unpaired t-test. For analysis between groups, the Kruskal-Wallis test was used, followed by the Mann-Whitney U test. Differences were considered significant at p<0./05.

Results

MAP and heart rate were 87±7 mm Hg and 320±20 beats/min during baseline conditions and they did not change significantly after ischemic reperfusion or ultrasound exposure.

Changes in Arteriolar Diameter and RBC Velocity

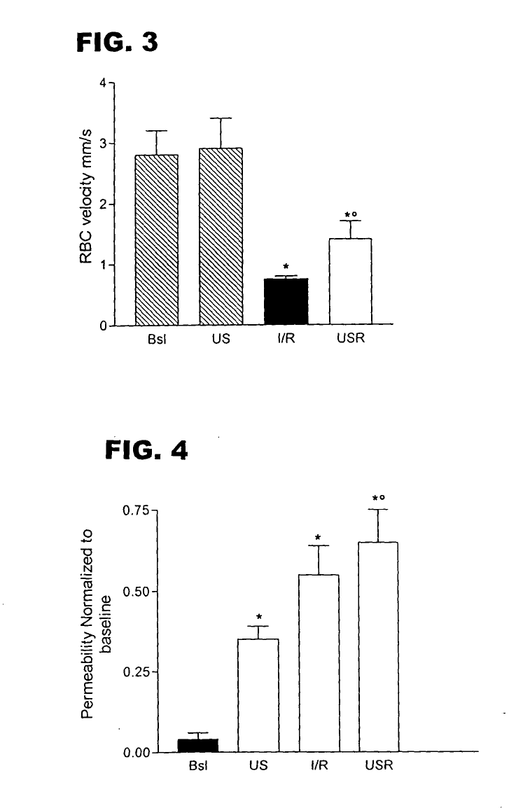

In FIGS. 2B and 3 we reported the arteriolar diameter and RBC velocity immediately after the ultrasound exposure during baseline and reperfusion. Arteriolar diameter was unchanged during baseline. During reperfusion arterioles constructed significantly (baseline: 35±7 μm, I/R: 20±μm, pM0.05, n=15) in the ischemic reperfusion group while with ultrasound exposure the arterioles showed a significant vasodilation by 40% (p<0.05) on reperfusion. RBC velocity increased significantly by 64% in arterioles during reperfusion in comparison with ischemic reperfusion group (baseline: 2.8±0.4 mm /s; I/R: 0.75±0.05 mm/s, p<0.01).

Changes in FITC-dextran Leakage

In the ischemic reperfusion group a significant increase in permeability was observed in postcapillary and collecting venules and in capillaries during postischemic reperfusion (FIG. 4). Ultrasound determined a significant increase in FITC-dextran leakage during baseline (baseline: 0.05±0.02 US: baseline: 0.35±0.04 normalized grey levels, p<0.01). With ultrasound exposure during reperfusion there was a significant increase in permeability.

Changes Its Leukocyte Adhesion on Postcapillary Venules

In the ischemic reperfusion group there was a significant increase in leukocyte adhesion after reperfusion. Leukocyte adhesion was rarely observed throughout the baseline observations or during ultrasound whereas the leukocyte adhesion on venular wall increased significantly in ischemic reperfusion and USR groups after reperfusion. (FIG. 5, p<0.05). However, in the group treated with ultrasound the increase in leukocyte adhesion was 31% lower than in ischemic reperfusion group (p<0.05).

Changes in Capillary Perfusion

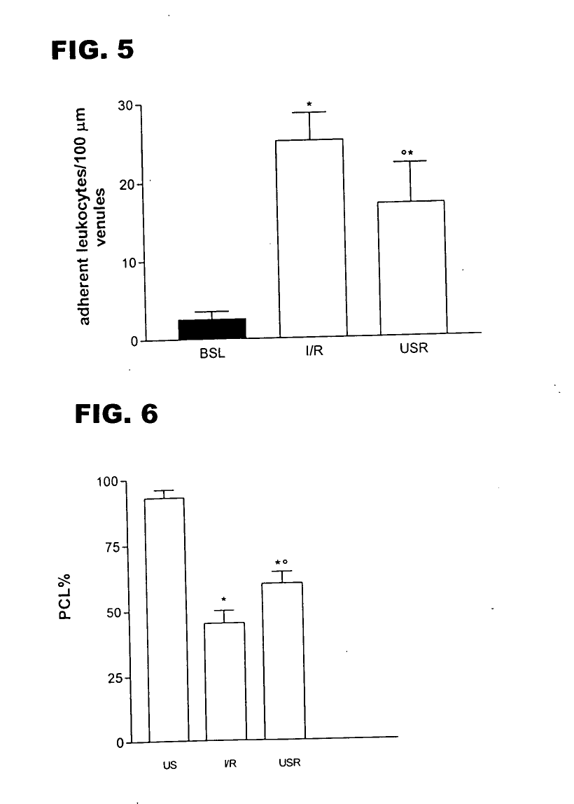

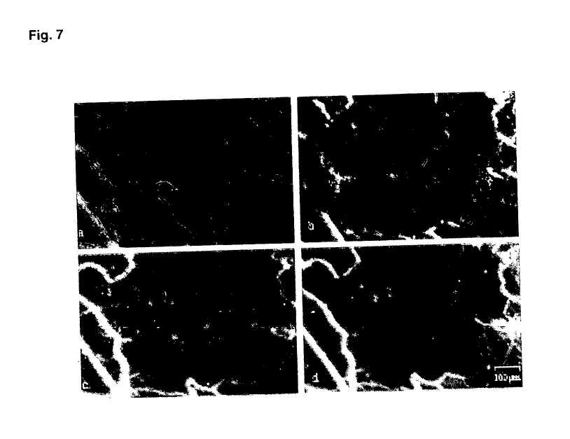

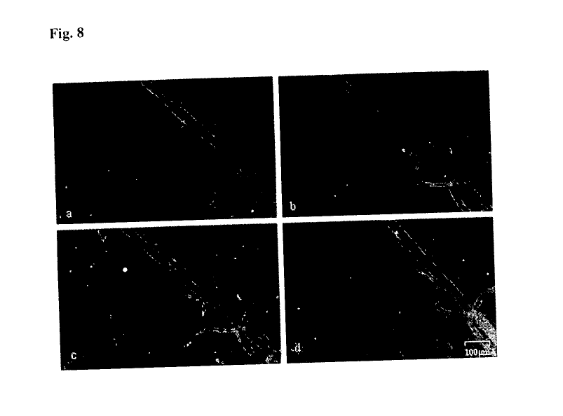

US exposure during baseline caused a 7±2% reduction in PCL which was significant (FIG. 6, p<0.05). During baseline in some capillaries there was only a transient stoppage of flow that recovered after the observation period. In ischemic reperfusion group PCL was reduced significantly when compared with baseline (baseline: 9,279±530 μm, p<0.05, FIG. 6). However, immediately after ultrasound during reperfusion almost all the microvasculature was perfused. This was followed by a significant decrease after a period of 30 min of reperfusion, although capillary perfusion was higher than in ischemic reperfusion group (baseline: 8,950±780 μm). In FIGS. 7-8 we reported the photographic sequence of a control and ultrasound treated-hamster cheek pouch microcirculation during baseline, 30 min of ischemia, 5 min and 30 min of reperfusion. In FIG. 7 it is evident the decrease in capillary perfusion after reperfusion while in the hamster treated with ultrasound there is increased capillary perfusion associated with arterial and venous dilation.

Lipoperoxidation Test

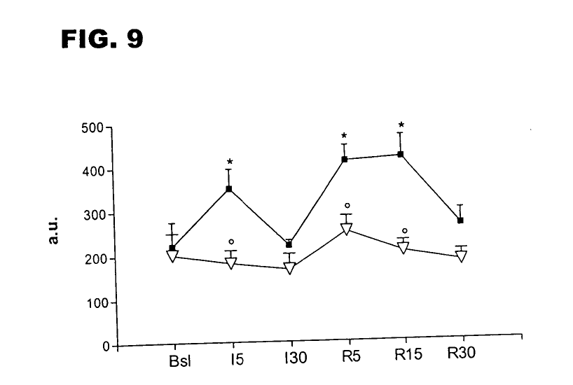

In control group with ischemic reperfusion ROS increased after 5 min of ischemia (FIG. 9). After 5 min of reperfusion there was a significant increase of ROS that remained at increased levels throughout reperfusion for 30 min. Ultrasound decreased lipoperoxide concentration during baseline (sham: 200±55 a.u.; US: 148±36 a.u., p<0.05) and decreased significantly by 39 and 51% vs. ischemic reperfusion group at 5 and 15 min of reperfusion.

Discussion

The main findings of our study is that in our microvascular model of ischemic reperfusion injury, cardiac ultrasound of current diagnostic use had a moderate beneficial effect on hemodynamic indices of microcirculatory perfusion, because on reperfusion they improved arteriolar vasodilation and attenuated leukocyte adhesion. We additionally assessed ROS formation in real time in the in vivo microcirculation showing that ultrasound reduced ROS production during baseline conditions and reperfusion. However, ultrasound caused an increase in permeability during baseline and reperfusion.

Oxidative Stress and Ultrasound Exposure

We have shown previously that US, with high mechanical index, modulates the production of ROS in the extracellular medium thus mediating damage to endothelial cells in vitro (6). Furthermore, no endothelial cell damage can be observed in vitro when the ultrasound exposure is kept below 15 min. Therefore, we used an ultrasound exposure of 15 min in the present study. In the absence of microbubbles potentiating cavitations phenomena, this energy does not induce endothelial damage also in vivo (21).

I/R have been shown to be associated with increased oxidative stress, as evidenced also by our measurements showing an increased ROS formation during early ischemia and at the beginning of reperfusion. Ultrasound abrogated the oxidative stress thus attenuating the leukocyte adhesion on venules and increasing the capillary perfusion at early reperfusion. On reperfusion, ultrasound exposure was associated with greater arteriolar diameter thus causing immediate capillary perfusion. After reperfusion there was a reduction in capillary perfusion that was significantly lower than in ischemic reperfusion group.

Reduced ROS formation occurs during baseline condition as well as during ischemic reperfusion thus showing that ultrasound initiates a process that blocks the rise in ROS. We hypothesize that this protective mechanism may be due to mechanical perturbations leading to repulsive interactions between bilayers of the endothelial cell membrane. This effect might per se improve perfusion and exert an anti-oxidant effect by enhancing fluctuations in shear stress exerted by the flowing blood on the vessel wall. Recent data suggest that ROS are important second messengers in endothelial cells and that flow modulates the endothelial cell redox state (22). Nonetheless, neither the signaling sequence nor the mechanism by which ROS lead to damage has been elucidate. The phenomenon is complex since the magnitude and the pattern of shear stress (oscillatory or random) acting on endothelial cells depends on blood flow, plasma viscosity and vascular geometry. It is accepted that steady laminar flow activates antioxidant mechanisms whereas oscillatory and turbulent flow stimulates prooxidant mechanisms (23-25).

One of the earlier observed abnormalities in reperfusion-induced injury is an endothelial dysfunction manifested as loss of NO dependent vasodilation. This phenomenon occurs within 2-5 min of reperfusion, as shown also by Tsa et al. in ischemia reperfused rat hearts (26). Therefore, the vasodilatory effect of ultrasound could be due to changes of shear stress on the endothelium leading to the maintenance of NO formation. This phenomenon could be especially relevant during postischemic reperfusion, when arterioles are vasoconstricted due to decreased NO formation. The protection of this effect can be enforced by the decreased production of other radical species by endothelial cells during ultrasound exposure.

An alternative hypothesis could be that mechanical fluctuations caused by ultrasound stimulation might exert a direct vasodilatory effect on arteriolar smooth muscle cell thus modulating conduit vessel diameter and vascular resistance due to a process of vascular smooth muscle relaxation. This vasorelaxant effect of ultrasonic energy (at frequency of 20 KHz) determines endothelium independent smooth muscle cell relaxation capable of reversing both receptor-mediated and voltage-dependent vasoconstriction in vivo (28). This effect is likely to be non-thermal and non-cavitational, since the employed frequency do not increase temperature and are associated, in the absence of bubble, to very little cavitation phenomena (21).

The increase in permeability observed during baseline conditions and after reperfusion could not be related to an increase in ROS formation as suggested by al-Karmi et al showed changes in ion conductance of frog skin after therapeutic ultrasound (27). However, ultrasound may affect cell to cell communication thus changing the conductance of the gap junctions and increasing the extravascular leakage.

We observed a decreased leukocyte adhesion that may be due to the decreased ROS production, the increased shear stress and the NO increased production. The decreased leukocyte adhesion may also cause an increase in capillary perfusion thus determining an increased blood flow and oxygen supply in the microcirculation.

The glycocalix could be also another parameter affected by oscillations of the membrane caused by USE. Mulivor and Lipowsky suggested that glycocalix serves as a barrier to adhesion and its shedding during natural activation of endothelial cell may be an essential part of the inflammatory response (29). In vitro attempts to measure the functional thickness of the glycocalix revealed a range from 400 to 500 nm. It is plausible to suggest that energetic oscillation caused by ultrasound may limit the ability to support selectin-mediated rolling of leukocytes among the macromolecular components of the glycocalix, carbohydrates and glycoproteins such as glycoaminoglycans and glycolipids. Because leukocyte cannot roll along the endothelial cells, adhesion cannot be enhanced by reperfusion-induced damage.

Conclusion

Diagnostic ultrasound is an environment-friendly and biohazard-free imaging technology. However, they are not biologically inert. The microcirculation is mainly sensitive to ultrasound exposure with frequency, intensity and duration fully within the cardiac diagnostic range. In the hamster cheek pouch, both during baseline and reperfusion, ultrasound exposure increases endothelial permeability which is an early and reversible sign of microcirculatory damage, likely due to loosening of cell-to-cell tight junctions for mechanical low amplitude vibrations. This low-level endothelial damage in baseline conditions is likely to cause some kind of preconditioning thus leading to a state of increased resistance during reperfusion. In light of our finding of reduced ROS formation during ischemia and reperfusion after ultrasound exposure it appears that endothelial cells are better preserved and suggest that this is responsible for improved vasodilation, partial reduction of leukocytes adhesion and increased capillary perfusion. The most likely beneficial effect of ultrasound takes place through non-thermal, non-cavitational mechanisms. Low amplitude mechanical oscillations caused by ultrasound may change oscillatory shear stress exerted by the flowing blood on endothelial cells thus increasing its anti-oxidant activity.
1. Nyoborg W L. Biological effects of ultrasound development of safety guidelines. Part II: general review. Ultrasound Med Biol 2001; 27: 301-33.
2. Baker K G, Robertson V J, Duck F A. Therapeutic ultrasound has traditionally been regarded as having a strong biophysical basis. Physical Therapy 2001; 81: 1352-58.
3. Miller M W, Miller D L, Brayman A A. A review of in vitro bioeffects of inertial ultrasonic cavitation from a mechanistic perspective. Ultrasound Med Biol 1996; 22: 1131-54.
4. Riesz P, Kondo T. Free radical formation induced by ultrasound and its biological implications. Free Radical Biol Med 1992; 13: 247-70.
5. Riesz P, Bergahl D, Christman C L. Free radical generation by ultrasound in acqueous and non acqueous solutions. Environ Health Perspect 1985; 64: 223-52.
6. Basta G, Venneri L, Lazzerini G, Pasanisi E, Pianelli M, Vesentini N, Del turco S, Picano E. In vitro modulation of intracellular oxidative stress of endothelial cell by diagnostic cardiac ultrasound. Cardiovasc Res 2003; 58(1): 156-61.
7. Ay T, Havaux X, Van Camp G. Destruction of contract microbubbles by ultrasound. Effect on myocardial function coronary perfusion pressure, and microvascular integrity. Circulation 2001; 104: 461-66.
8. Miller D L, Quddus J. Diagnostic ultrasound activation of contrast agent gas bodies induces capillary rupture in mice. PNAS 2000; 97: 10179-184.
9. Opie L H. Microcirculatory damage is a crucial. Normal and abnormal cardiac function. In: Braunwald E, Zipes D P, Libby P (eds) Heart Disease. A textbook of cardiovascular medicine. 6^{th} ed. W B Saunders Co., Philadelphia, New York, 2001.
10. Brayman A A, Lizotte L M, Miller M W. Erosion of artificial endothelial in vitro by pulsed ultrasound: acoustic pressure frequency, membrane orientation and microbubble contract agent dependence. Ultras in Med Biol 1999; 25: 1305-20.
11. Feigenbaum H, Fisher N G, Christiansen J P, Klibanov A et al. Influence of microbubbles on capillary transit and myocardial contract enhancement. J Am Coll Cardiol 2002: 40: 811-19.
12. Picano E. Expanding application of clinical ultrasound Stress Echocardiography. 4^{th} edition. Springer Verlag. New York, Neidelberg, 2003.
13. Barnett S. Free radical production its biological consequences. Ultras in Med & Biol 1998; 24: S29-34.
14. Halliwel B, Gutterridge J M G. Free radicals in biology and medicine. 2^{nd} ed. London, Clarendon Press, 1989.
15. Matsuo H. Enhancement of ultrasound accelerated thrombolysis by echo contrast agents, dependence on microbubble structure. Ultrasound Med Biol 1999; 9: 1431-7.
16. Edmonds P D, Sancier K M. Evidence for free radical production by ultrasonic cavitation in biological media. Ultrasound Med Biol 1983; 635-9.
17. Bertuglia S, Calantuoni A. Protective effects of leucopenia and t-PA in ischemia reperfusion injury in hamster cheek pouch microcirculation. Am J Physiol 2000; 278: H755-61.
18. Bertuglia S, Giusti A, Fedele S, Picano E. Glucose-insulin-potassium treatment in combination with dipyridamole inhibits ischemia-reperfusion-induced damage. Diabetologia 2001; 44: 2165-70.
19. Bertuglia S, Giusti A, Pittman R N. Microcirculatory oxygenation and oxygen free radical generation during ischemia and reperfusion. J Vasc Res 2002; 39, 32.
20. Cesarone M R, Belcaro G, Carratelli M. A simple test to monitor oxidative stress. Intern Angiol 1999; 18: 127-30.
21. Carstensen E L, Gracewski S, Dalecki D. The search for cavitation in vivo. Ultrasound Med Biol. 2000; 26(9): 1377-85.
22. Bradford C B. Redox signals that regulate the vascular response to injury. Thrombosis and hemostasis. 1999; 82:810-7.
23. Lin K, Pin-Pin H, Chen B P, et al. Molecular mechanism of endothelial growth arrest by laminar shear stress. PNAS 2000; 97:9285-89.
24. Inoue N, Ramasamy S, Fukay T, Nerem R M, Harrison H. Shear stress modulates expression of Cu/Zn superoxide dismutase in human aortic endothelial cells. Circ Res 1996; 79:32-7.
25. Topper J N, Cai F, Falb D, Gimbrone M A, Jr. Identification of molecular endothelial genes differentially responsive to fluid shear stress stimuli, cyclooxygenase-2, manganese superoxide and endothelial cell nitric oxide synthase are selectively regulated by steady laminar shear stress. Proc Natl Acad 1996; 93: 10417-22.
26. Tsao P S, Lefer A M. Time course and mechanism of endothelial dysfunction in isolated ischemic and hypoxic perfused rat hearts. Am J Physoil 1990: 259:H1660-6.
27. al-Karmi A M, Dinno, M A, Stoltz D A, Crum L A, Matthews J C. Calcium and the effects of ultrasounds in frog skin. Ultrasound Med Biol 1994; 20(1):73-81.
28. Fischell T A, Abbas M A, Grant G W, Siegel R J. Ultrasonic energy. Effects on vascular function and integrity. Circulation 1991: 84(4):1783-95.
29. Mulivor A W, Lipowsky H H. Role of glycocalyx in leukocyte-endothelial cell adhesion. Am J Physiol 2002; 284:H1282-91.

Although the foregoing invention has, for the purposes of clarity and understanding, been described in some detail by way of illustration and example, it will be obvious that certain changes and modifications may be practiced that will still fall within the scope of the appended claims. For example, the devices and features depicted or described in any figure or embodiment can be used in any of the other depicted embodiments. Further, all references cited herein are expressly incorporated by reference as if set forth herein in their entirety.

1. A method for stimulating perfusion, comprising the steps of:
selecting a patient having a tissue with compromised microvascular perfusion;
applying an ultrasound transducer to a location near the tissue; and
activating the transducer to initiate exposure of the tissue to ultrasound at a frequency of 100 KHz to 2.0 MHz for a duration of 0.5 to 15 minutes, wherein local vasodilatation is stimulated.

2-9. (Cancelled)

10. A method for stimulating reperfusion in a patient having a tissue experiencing an ischemic injury, comprising the steps of:
selecting a patient experiencing a myocardial infarction;
applying a portable transcutaneous ultrasound transducer within 30 minutes after the ischemic injury to a location near the tissue at the site of the ischemic injury;
activating the transducer to initiate exposure of the tissue to ultrasound and thereby stimulate local vasodilatation; and
confirming the establishment of reperfusion.

11. The method of claim 10, further comprising the steps of applying a gel to enhance the transmission of ultrasound waves.

12. The method of claim 10, further comprising the steps of adjusting the focal length of the ultrasound waves.

13. The method of claim 10, wherein the frequency of the ultrasound waves is 100 KHz to 2.0 MHz.

14. The method of claim 10, wherein the ultrasound exposure is maintained for 15 minutes.

15. The method of claim 10, wherein the step of confirming the establishment of reperfusion comprises a procedure selected from the group consisting of angiography, electrocardiogram, diagnostic ultrasound, and measuring blood levels of creatine kinase.

16. The method of claim 10, further comprising the steps of injecting an anticlotting agent into the patient.

17. The method of claim 16, wherein the anticlotting agent is selected from the group consisting of aspirin, tissue plasminogen activator, and streptokinase.

18. A method for stimulating myocardial perfusion, comprising the steps of:
selecting a patient having a myocardium with compromised perfusion;
applying an ultrasound transducer to a location near the myocardium; and
activating the transducer to initiate exposure of the myocardium to ultrasound at a frequency of 100 KHz to 2.5 MHz, wherein myocardial blood flow is enhanced.

19. The method of claim 18, further comprising the step of confirming enhancement in myocardial blood flow.

20. The method of claim 18, wherein the transducer is activated to initiate exposure to ultrasound at a frequency of 100 KHz to 1.0 MHz.

21. The method of claim 18, wherein the transducer is activated to initiate exposure to ultrasound at a frequency of 100 KHz to 200 KHz.

22. The method of claim 18, wherein the exposure to ultrasound is for a duration of exposure is 0.5 to 15 minutes.

23. The method of claim 18, wherein the exposure to ultrasound is for a duration of exposure is 0.5 to 10 minutes.

24. The method of claim 18, wherein the exposure to ultrasound is for a duration of exposure is 5 to 10 minutes.

25. The method of claim 18, wherein the transducer is activated to initiate exposure to ultrasound with a temporal and spatial average energy level of 0.01 to 1.00 watts/cm².

26. The method of claim 18, wherein the transducer is activated to initiate exposure to ultrasound with pulsed modulation.

27. (Cancelled)

28. A method for stimulating cerebral perfusion, comprising the steps of:
selecting a patient having a cerebral tissue with compromised perfusion;
applying an ultrasound transducer to a location near the head; and
activating the transducer to initiate exposure of the head to ultrasound at a frequency of 100 KHz to 2.5 MHz, wherein cerebral blood flow is enhanced.

29-37. (Cancelled)

38. A method for stimulating perfusion in a transplanted tissue, comprising the steps of:
selecting a patient having a transplanted tissue;
applying an ultrasound transducer to a location near the transplanted tissue; and
activating the transducer to initiate exposure of the transplanted tissue to ultrasound at a frequency of 100 KHz to 2.0 MHz for a duration of 0.5 to 15 minutes, wherein local vasodilatation is stimulated.

39-51. (Cancelled)
